(19) United States
(12) Patent Application Publication
(10) Pub. No.: US 2023/0103932 A1
(43) Pub. Date: Apr. 6, 2023

(54) Motion Sensor Modules with Dynamic Protocol Support for Communications with a Computing Device

(71) Applicant: Finch Technologies Ltd., Fish Bay (VG)

(72) Inventors: Viktor Vladimirovich Erivantcev, Ufa (RU); Rustam Rafikovich Kulchurin, Ufa (RU); Kirill Alexandrovich Kastriukin, Ufa (RU); Savva Alexeyevich Chiglintsev, Ufa (RU); Vyacheslav Ivanovich Lebets, Rostov-on-Don (RU)

(21) Appl. No.: 17/495,602

(22) Filed: Oct. 6, 2021

(51) Int. Cl. G06F 3/0346; G06F 3/01; G06F 3/0354; G06F 3/038

(52) U.S. Cl. CPC G06F 3/0346; G06F 3/011; G06F 3/0354; G06F 3/0383; G06F 2203/0384

(57) ABSTRACT

A system having a sense module and a computing device. The sensor module has an inertial measurement unit to generate 3D inputs. The sensor module can map the 3D inputs to 2D inputs and transmit the 3D inputs and 2D inputs using separate protocols simultaneously, such as a universal asynchronous receiver-transmitter protocol and a human device interface protocol. The 2D inputs can be processed via default drivers of a typical operation system and thus can be used without customization of a host computing device. The 3D inputs can be processed via a custom driver or tool designed for the computing device. When the custom tool is available, the computing device can instruct the sensor module to stop transmitting via the 2D protocol. Otherwise, the transmitting via the 3D protocol can be stopped without reboot or restarting the computing device and/or the sensor module.

### RELATED APPLICATIONS

The present application relates to U.S. patent application Ser. No. 16/433,619, filed Jun. 6, 2019, issued as U.S. Pat. No. 11,009,964 on May 18, 2021, and entitled “Length Calibration for Computer Models of Users to Generate Inputs for Computer Systems,” U.S. patent application Ser. No. 16/375,108, filed Apr. 4, 2019, published as U.S. Pat. App. Pub. No. 2020/0319721, and entitled “Kinematic Chain Motion Predictions using Results from Multiple Approaches Combined via an Artificial Neural Network,” U.S. patent application Ser. No. 16/044,984, filed Jul. 25, 2018, issued as U.S. Pat. No. 11,009,941, and entitled “Calibration of Measurement Units in Alignment with a Skeleton Model to Control a Computer System,” U.S. patent application Ser. No. 15/996,389, filed Jun. 1, 2018, issued as U.S. Pat. No. 10,416,755, and entitled “Motion Predictions of Overlapping Kinematic Chains of a Skeleton Model used to Control a Computer System,” U.S. patent application Ser. No. 15/973,137, filed May 7, 2018, published as U.S. Pat. App. Pub. No. 2019/0339766, and entitled “Tracking User Movements to Control a Skeleton Model in a Computer System,” U.S. patent application Ser. No. 15/868,745, filed Jan. 11, 2018, issued as U.S. Pat. No. 11,016,116, and entitled “Correction of Accumulated Errors in Inertial Measurement Units Attached to a User,” U.S. patent application Ser. No. 15/864,860, filed Jan. 8, 2018, issued as U.S. Pat. No. 10,509,464, and entitled “Tracking Torso Leaning to Generate Inputs for Computer Systems,” U.S. patent application Ser. No. 15/847,669, filed Dec. 19, 2017, issued as U.S. Pat. No. 10,521,011, and entitled “Calibration of Inertial Measurement Units Attached to Arms of a User and to a Head Mounted Device,” U.S. patent application Ser. No. 15/817,646, filed Nov. 20, 2017, issued as U.S. Pat. No. 10,705,113, and entitled “Calibration of Inertial Measurement Units Attached to Arms of a User to Generate Inputs for Computer Systems,” U.S. patent application Ser. No. 15/813,813, filed Nov. 15, 2017, issued as U.S. Pat. No. 10,540,006, and entitled “Tracking Torso Orientation to Generate Inputs for Computer Systems,” U.S. patent application Ser. No. 15/792,255, filed Oct. 24, 2017, issued as U.S. Pat. No. 10,534,431, and entitled “Tracking Finger Movements to Generate Inputs for Computer Systems,” U.S. patent application Ser. No. 15/787,555, filed Oct. 18, 2017, issued as U.S. Pat. No. 10,379,613, and entitled “Tracking Arm Movements to Generate Inputs for Computer Systems,” and U.S. patent application Ser. No. 15/492,915, filed Apr. 20, 2017, issued as U.S. Pat. No. 10,509,469, and entitled “Devices for Controlling Computers based on Motions and Positions of Hands.” The entire disclosures of the above-referenced related applications are hereby incorporated herein by reference.

### TECHNICAL FIELD

At least a portion of the present disclosure relates to computer input devices in general and more particularly but not limited to input devices for virtual reality and/or augmented/mixed reality applications implemented using computing devices, such as mobile phones, smart watches, similar mobile devices, and/or other devices, such as Internet of Things (IoT) devices.

### BACKGROUND

U.S. Pat. App. Pub. No. 2014/0028547 discloses a user control device having a combined inertial sensor to detect the movements of the device for pointing and selecting within a real or virtual three-dimensional space.

U.S. Pat. App. Pub. No. 2015/0277559 discloses a finger-ring-mounted touchscreen having a wireless transceiver that wirelessly transmits commands generated from events on the touchscreen.

U.S. Pat. App. Pub. No. 2015/0358543 discloses a motion capture device that has a plurality of inertial measurement units to measure the motion parameters of fingers and a palm of a user.

U.S. Pat. App. Pub. No. 2007/0050597 discloses a game controller having an acceleration sensor and a gyro sensor. U.S. Pat. No. D772,986 discloses the ornamental design for a wireless game controller.

Chinese Pat. App. Pub. No. 103226398 discloses data gloves that use micro-inertial sensor network technologies, where each micro-inertial sensor is an attitude and heading reference system, having a tri-axial micro-electromechanical system (MEMS) micro-gyroscope, a tri-axial micro-acceleration sensor and a tri-axial geomagnetic sensor which are packaged in a circuit board. U.S. Pat. App. Pub. No. 2014/0313022 and U.S. Pat. App. Pub. No. 2012/0025945 disclose other data gloves.

U.S. Pat. App. Pub. No. 2016/0085310 discloses techniques to track hand or body pose from image data in which a best candidate pose from a pool of candidate poses is selected as the current tracked pose.

U.S. Pat. App. Pub. No. 2017/0344829 discloses an action detection scheme using a recurrent neural network (RNN) where joint locations are applied to the recurrent neural network (RNN) to determine an action label representing the action of an entity depicted in a frame of a video.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a sensor module configured with the capability to communicate motion inputs to a computing device using multiple protocols according to one embodiment.

FIG. 2 illustrates a system to track user movements according to one embodiment.

FIG. 3 illustrates a system to control computer operations according to one embodiment.

FIG. 4 illustrates a skeleton model that can be controlled by tracking user movements according to one embodiment.

FIG. 5 shows a technique to automatically configure the transmission protocol between a sensor module and a computing device according to one embodiment.

FIG. 6 shows a method to support dynamic protocol selection in a sensor module according to one embodiment.

### DETAILED DESCRIPTION

The following description and drawings are illustrative and are not to be construed as limiting. Numerous specific details are described to provide a thorough understanding. However, in certain instances, well known or conventional details are not described to avoid obscuring the description. References to one or an embodiment in the present disclosure are not necessarily references to the same embodiment; and, such references mean at least one.

At least some embodiments disclosed herein allow a plurality of sensor modules to be attached to various parts or portions of a user, such as hands and arms, to generate inputs to control a computing device based on the tracked motions of the parts of the user. The inputs of a sensor module are generated at least in part by an inertial measurement unit (IMU). The sensor module can communicate its inputs to the computing device using multiple protocols, and can dynamically change from using one protocol to another without requiring the sensor module and/or the computing device to restart or reboot.

For example, an inertial measurement unit (IMU) is configured in a sensor module to measure its orientation and/or position in a three dimensional (3D) space; and the 3D motion parameters of the sensor module, such as the position, orientation, speed, rotation, etc. of the sensor module, can be transmitted to a computing device as user inputs to control an application of virtual reality (VR), mixed reality (MR), augmented reality (AR), or extended reality (XR). Optionally, the sensor module can further include other input devices, such as a touch pad, a joystick, a button, etc., that are conventionally used to generate inputs for a 2D graphical user interface Optionally, the sensor module can also include output devices, such as a display device, an LED light, and/or a haptic actuator to provide feedback from the application to the user via the sensor module.

Human Interface Device (HID) protocol is typically used to communicate input data to a computer from conventional 2D user input devices, such as keyboards, computer mice, game controllers, etc. A typically operating system of a computing device has one or more default drivers to process inputs from a conventional keyboard, computer mouse, pen tablet, or game controller without the need to install a custom driver specific for the keyboard, computer mouse, pen tablet, or game controller manufactured by a specific vendor.

A sensor module can be configured to communicate at least a portion of its inputs to a computing device using the Human Interface Device (HID) protocol without the need to install a custom driver specific for the sensor module. When the Human Interface Device (HID) protocol is used, the sensor module can configure its inputs to emulate the input of a typical keyboard, computer mouse, pen tablet, and/or game controller. Thus, the sensor module can be used without customizing or installing a driver in the computing device running the VR/MR/AR/XR/IoT application and/or an Internet of Things (IoT) device.

Universal Asynchronous Receiver-Transmitter (UART) is a protocol that have been used in many device to device communications. The sensor module can be further configured to support communication with the computing device using the Universal asynchronous receiver-transmitter (UART) protocol to provide 3D input data. When the computing device has a custom driver installed to support communications of 3D input data via Universal Asynchronous Receiver-Transmitter (UART) protocol, the sensor module can provide further input data in ways that are not supported by a typical/default Human Interface Device (HID) driver available for conventional input devices.

The sensor module can be configured to automatically provide input data in both Human Interface Device (HID) protocol and Universal Asynchronous Receiver-Transmitter (UART) protocol. Thus, when the sensor module is used with a computing device that does not have a customer Universal Asynchronous Receiver-Transmitter (UART) driver for 3D input data from the sensor module, the computing device can process the 2D input data transmitted via the Human Interface Device (HID) protocol using a default driver available for operating conventional input devices, such as a keyboard, a computer mouse, a pen tablet, or a game controller.

When the sensor module is used with a computing device that has installed a customer Universal Asynchronous Receiver-Transmitter (UART) driver for 3D input data from the sensor module, the computing device can optionally use both the 2D input data transmitted using the Human Interface Device (HID) protocol and/or the 3D input data transmitted using the Universal Asynchronous Receiver-Transmitter (UART) protocol.

For example, 2D input data generated via buttons, touch pads, joysticks, etc. of the sensor module can be communicated via the Human Interface Device (HID) protocol; and at least 3D motion inputs generated by an inertial measurement unit (IMU) can be transmitted via the Universal Asynchronous Receiver-Transmitter (UART) protocol.

In some implementations, when a communication link in Universal Asynchronous Receiver-Transmitter (UART) protocol is established between the sensor module and the computing device, the custom Universal Asynchronous Receiver-Transmitter (UART) driver running in the computing device can instruct the sensor module to stop transmitting via the Human Interface Device (HID) protocol. Thus, the sensor module can seamlessly transition between transmitting in both the Human Interface Device (HID) protocol and the Universal Asynchronous Receiver-Transmitter (UART) protocol and transmitting only in the Universal Asynchronous Receiver-Transmitter (UART) protocol (or only in the Human Interface Device (HID) protocol), without a need to restart or reboot the sensor module and/or the computing device.

Optionally, a custom Human Interface Device (HID) driver can be installed in the computing device; and the driver can instruct the sensor module to stop transmitting in Universal Asynchronous Receiver-Transmitter (UART) protocol. Thus, the sensor module can switch its use of protocol for input transmission without the need to reboot or restart the sensor module and/or the computing device.

The sensor module can be configured to recognize data or commands received from the computing device in the Human Interface Device (HID) protocol and data or commands received from the computing device in the Universal Asynchronous Receiver-Transmitter (UART) protocol. Thus, the computing device can use the Universal Asynchronous Receiver-Transmitter (UART) protocol and/or the Human Interface Device (HID) protocol to instruct the sensor module to start or stop transmitting input data of the sensor module using any of the protocols, such as the Human Interface Device (HID) protocol, or the Universal Asynchronous Receiver-Transmitter (UART) protocol.

For example, when the sensor module is transmitting inputs via the Human Interface Device (HID) protocol, a custom Universal Asynchronous Receiver-Transmitter (UART) driver running in the computing device for the sensor module can request the sensor module to stop transmitting using the Human Interface Device (HID) protocol and start transmitting using the Universal Asynchronous Receiver-Transmitter (UART).

Similarly, when the sensor module is transmitting inputs via the Universal Asynchronous Receiver-Transmitter (UART) protocol, a custom Human Interface Device (HID) driver running in the computing device for the sensor module can request the sensor module to start transmitting using the Human Interface Device (HID) protocol and stop transmitting using the Universal Asynchronous Receiver-Transmitter (UART) protocol.

Thus, the sensor module and the computing device can optionally switch protocols used for transmitting inputs from the sensor module to the computing device without the need to restart or reboot either the sensor module or the computing device. For example, transmitting input data via Human Interface Device (HID) protocol can be advantageous in one usage pattern of the sensor module; and transmitting input data via Universal Asynchronous Receiver-Transmitter (UART) protocol can be advantageous in another usage pattern of the sensor module. Based on a current usage pattern of the sensor module in the VR/XR/AR/MR or IoT application, the computing device can instruct the sensor module to switch to the use of a protocol that is most advantageous for the current usage pattern. In some instances, it is advantageous to use both protocols for transmitting different types of data concurrently.

The position and orientation of a part of the user, such as a hand, a forearm, an upper arm, the torso, or the head of the user, can be used to control a skeleton model in a computer system. The state and movement of the skeleton model can be used to generate inputs in a virtual reality (VR), mixed reality (MR), augmented reality (AR), or extended reality (XR) application. For example, an avatar can be presented based on the state and movement of the parts of the user.

A skeleton model can include a kinematic chain that is an assembly of rigid parts connected by joints. A skeleton model of a user, or a portion of the user, can be constructed as a set of rigid parts connected by joints in a way corresponding to the bones of the user, or groups of bones, that can be considered as rigid parts.

For example, the head, the torso, the left and right upper arms, the left and right forearms, the palms, phalange bones of fingers, metacarpal bones of thumbs, upper legs, lower legs, and feet can be considered as rigid parts that are connected via various joints, such as the neck, shoulders, elbows, wrist, and finger joints.

In some instances, the movements of a kinematic chain representative of a portion of a user of a VR/MR/AR/XR/IoT application can have a pattern such that the orientations and movements of some of the parts on the kinematic chain can be used to predict or calculate the orientations of other parts. For example, based on the orientation of an upper arm and a hand, the forearm connecting the upper arm and the hand can be predicted or calculated, as discussed in U.S. Pat. No. 10,379,613. For example, based on the orientation of the palm of a hand and a phalange bone on the hand, the orientation of one or other phalange bones and/or a metacarpal bone can be predicted or calculated, as discussed in U.S. Pat. No. 10,534,431. For example, based on the orientation of the two upper arms and the head of the user, the orientation of the torso of the user can be predicted or calculated, as discussed in U.S. Pat. Nos. 10,540,006, and 10,509,464.

The position and/or orientation measurements generated using inertial measurement units can have drifts resulting from accumulated errors. Optionally, an initialization operation can be performed periodically to remove the drifts. For example, a user can be instructed to make a predetermined pose; and in response, the position and/or orientation measurements can be initialized in accordance with the pose, as discussed in U.S. Pat. No. 10,705,113. For example, an optical-based tracking system can be used to assist the initialization in relation with the pose, or on-the-fly, as discussed in U.S. Pat. No. 10,521,011 and U.S. Pat. No. 11,016,116.

In some implementations, a pattern of motion can be determined using a machine learning model using measurements from an optical tracking system; and the predictions from the model can be used to guide, correct, or improve the measurements made using an inertial-based tracking system, as discussed in U.S. Pat. App. Pub. No. 2019/0339766, U.S. Pat. Nos. 10,416,755, and 11,009,941, and U.S. Pat. App. Pub. No. 2020/0319721.

A set of sensor modules having optical markers and IMUs can be used to facilitate the measuring operations of both the optical-based tracking system and the inertial-based tracking system. Some aspects of a sensor module can be found in U.S. patent application Ser. No. 15/492,915, filed Apr. 20, 2017, issued as U.S. Pat. No. 10,509,469, and entitled “Devices for Controlling Computers based on Motions and Positions of Hands.”

The entire disclosures of the above-referenced related applications are hereby incorporated herein by reference.

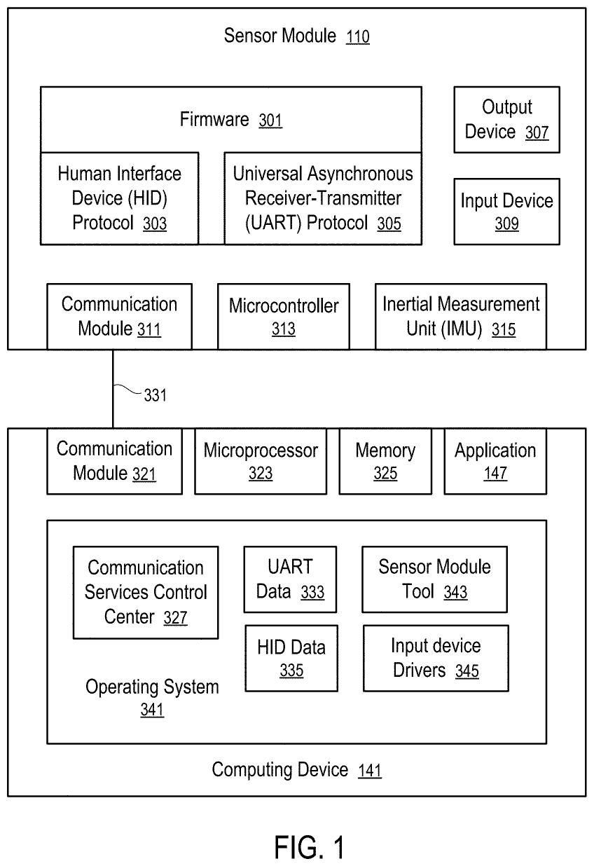

FIG. 1 shows a sensor module 110 configured with the capability to communicate motion inputs to a computing device 141 using multiple protocols according to one embodiment.

In FIG. 1, the sensor module 110 includes an inertial measurement unit 315 to measure motion parameters of the sensor module 110, such as the position, the orientation, the velocity, the acceleration, the and/or rotation of the sensor module 110. When the sensor module 110 is attached to a part of a user, the motion parameters of the sensor module 110 represent the motion parameters of the part of the user and thus motion-based input of the user to control an application 147 in the computing device 141

For example, the application 147 can be configured to present a virtual reality, an extended reality, an augmented reality, or a mixed reality, based on the motion input of the sensor module 110 (and/or other similar sensor modules).

In FIG. 1, the sensor module 110 has a microcontroller 313 and firmware 301 executable by the microcontroller 313 to implement a human interface device protocol 303 and a universal asynchronous receiver-transmitter protocol 305 concurrently.

Optionally, the sensor module 110 can include one or more input devices 309, such as a touch pad, a button, a joystick, a trigger, a microphone, etc.

Optionally, the sensor module 110 can include one or more output devices 307, such as an LED indicator, a speaker, a display device, a haptic actuator, etc.

The sensor module 110 includes a communication module 311 configured to communicate with a communication module 321 of the computing device 141 via a wired or wireless communication link 331.

The firmware 301 is configured to recognize instructions, requests, and/or outputs sent from the computing device 141 to the sensor module 110 in the human interface device protocol 303 and the universal asynchronous receiver-transmitter protocol 305.

For example, a request from the computing device 141 can instruct the sensor module 110 to start transmission of a particular type of input data (or all input data) using one of the protocols 303 and 305.

For example, a request from the computing device 141 can instruct the sensor module 110 to stop transmission of a particular type of input data (or all input data) using one of the protocols 303 and 305.

For example, an output from the computing device can be directed to an output device 307 (e.g., to turn on or off an LED indicator, to play a sound in a speaker, to present an image in a display device, to activate a haptic actuator).

For example, input data generated via the input device 309 can be transmitted primarily via the human interface device protocol 303; and the input data generated via the inertial measurement unit 315 can be transmitted primarily via the universal asynchronous receiver-transmitter protocol 305.

For example, when the sensor module 110 is instructed to stop transmitting using the human interface device protocol 303, at least some of the input data from the input device 309 can be re-configured for transmission via the universal asynchronous receiver-transmitter protocol 305.

For example, when the sensor module 110 is instructed to stop transmitting using the universal asynchronous receiver-transmitter protocol 305, at least some of the input data from the inertial measurement unit 315 can be converted (e.g., in an emulation mode) for transmission via the human interface device protocol 303.

Since the firmware 301 is configured to dynamically start or stop transmission using one or more of the protocols 303 and 305, the sensor module 110 can dynamically change transmission protocols without a need to restart or reboot.

The computing device 141 has an operating system 341. The operating system 341 can be stored in the memory 325 and be executable by a microprocessor 323, including a communication services control center 327, input device drivers 345, and an optional sensor module tool 343.

The sensor module tool 343 includes a driver to communicate via the universal asynchronous receiver-transmitter protocol 305. Optionally, the sensor module tool 343 includes a driver to communicate via the human interface device protocol 303.

When the sensor module tool 343 is absent from the computing device 141, one or more default input device drivers 345 configured for conventional input devices, such as a keyboard, pen tablet, computer mouse, or game controller, can be used to communicate with the sensor module 110 using the human interface device protocol 303. Thus, without the sensor module tool 343, at least a portion of the functionality of the sensor module 110 is usable to control the application 147 using data 335 transmitted from the sensor module 110 to the computing device 141 using the human interface device protocol 303.

When the sensor module tool 343 is available in the computing device 141, the computing device 141 can dynamically instruct the sensor module 110 to transmit some or all of input data from the sensor module 110 using one of the protocols 303 and 305. In some instances, a same input can be transmitted via both the human interface device protocol 303 and the universal asynchronous receiver-transmitter protocol 305. In other instances, inputs of one type are transmitted using the human interface device protocol 303 but not the universal asynchronous receiver-transmitter protocol 305; and inputs of another type are transmitted using the universal asynchronous receiver-transmitter protocol 305 but not the human interface device protocol 303.

In one implementation, the firmware 301 in the sensor module is able to connect and automatically switch between various protocols (e.g., 303 and 305) without rebooting or resetting the firmware 301.

The firmware 301 is programmed to support several data transfer protocols or services concurrently at the same time without rebooting the sensor module 110. For example, the firmware 301 can use both universal asynchronous receiver-transmitter protocol 305 and the human interface device protocol 303 at the same time in communicating with the computing device 141, or be instructed by the computing device 141 to use one of the protocols 303 and 305 as a priority service. When the sensor module tool 343 is available in the computing device 141, the computing device 141 can instruct the firmware 301 to switch from using the human interface device protocol 303 to using the universal asynchronous receiver-transmitter protocol 305, or vice versa.

A conventional input device for VR or AR applications (e.g., VR/AR headsets, smart glasses, smart viewers, etc.) uses a special protocol for transfer of data to a host device. Since such protocols are not standardized, such an input device may not work with a traditional host device, such as a personal computer, a smartphone, a tablet computer, a smart TV, etc.

A sensor module 110 configured according to FIG. 1 device can communicate with a computing device 141 having an operating system 341. For example, Bluetooth or Bluetooth Low Energy (BLE) can be used to establish a communication link 331 between the sensor module 110 and the computing device 141. The communication link 331 can be used to transfer data between the sensor module 110 and the computing device 141 to facilitate user interaction with the VR/AR/MR/XR/IoT application 147.

Since the firmware 301 allows more than one form of device-to-device communication (e.g., using the protocols 303 and 305), the system of FIG. 1 is not required to reboot any of its components (e.g., the sensor module 110 and/or the computing device 141) to switch communication protocols.

In FIG. 1, the Communication Services Control Center (CSCC) 327 in the computing device 141 is configured to control the data streams (e.g., data 333 and/or 335) received via different communication services/protocols. For example, in absence of the sensor module tool 343, data 335 transmitted using the human interface device protocol 303 can be directed to default input device drivers 345. When the sensor module tool 343 is available in the computing device 141, at least the data 333 transmitted using the universal asynchronous receiver-transmitter protocol 305 can be directed to the sensor module tool 343 for processing. Optionally, the sensor module tool 343 has drivers for both data 333 and data 335 for optimized results in supporting the application 147.

In one implementation, when the human interface device protocol 303 is used, the microcontroller 313 is configured to convert the inputs from the inertial measurement unit 315 to emulate inputs from a keyboard, a computer mouse, a gamepad, a game controller, and/or a pointer. Since a typically computing device 141 has one or more default drivers to process such inputs, the computing device 141 can use the inputs from the sensor module 110 without installing the sensor module tool 343.

When the sensor module tool 343 is present in the computing device 141, the sensor module tool 343 can instruct the sensor module to 110 to provide inputs not supported by a conventional keyboard, computer mouse, gamepad, game controller, and/or pointer.

In one implementation, the sensor module 110 is configured to initially transmit inputs to the computing device 141 using both the human interface device protocol 303 and the universal asynchronous receiver-transmitter protocol 305.

When the communication services control center 327 receives both the data 333 transmitted using the universal asynchronous receiver-transmitter protocol 305 and the data 335 transmitted using the human interface device protocol 303, the communication services control center 327 determines whether the sensor module tool 343 is present in the computing device 141. If so, the data 335 is discarded, and the data 333 is directed to the sensor module tool 343. In response, the sensor module tool 343 can cause the computing device 141 to send a command to the sensor module 110 to stop transmission of data using the human interface device protocol 303. If the communication services control center 327 determines that the sensor module tool 343 is absent from the computing device 141, the communication services control center 327 can transmit a command to the sensor module 110 to stop transmitting data using the universal asynchronous receiver-transmitter protocol 305.

When the sensor module 110 is configured to transmit using the human interface device protocol 303, the computing device 141 can send a command to the sensor module 110 to switch to transmission using the universal asynchronous receiver-transmitter protocol 305 in response to a request from the sensor module tool 343. In response to the request from the sensor module tool 343 and a command from the communication services control center 327, the sensor module 110 can stop transmitting input data using the human interface device protocol 303 and start transmitting input data using the universal asynchronous receiver-transmitter protocol 305.

Similarly, when the sensor module 110 is configured to transmit using the universal asynchronous receiver-transmitter protocol 305, the computing device 141 can send a command to the sensor module 110 to switch to transmission using the human interface device protocol 303 in response to a request from the sensor module tool 343. In response to the request from the sensor module tool 343 and a command from the communication services control center 327, the sensor module 110 can stop transmitting input data using the universal asynchronous receiver-transmitter protocol 305 and start transmitting input data using the human interface device protocol 303.

In one embodiment, when the inputs are transmitted using the human interface device protocol 303, the inputs are mapped into a 2D space to emulate conventional 2D input devices, such as a keyboard, a game controller, a pointer, a touch pad, etc. When the inputs are transmitted using the universal asynchronous receiver-transmitter protocol 305, motion inputs in 3D can be provided to the application 147 via the sensor module tool 343. Thus, the system of FIG. 1 allows seamless switch between a 2D mode of input to the application 147 and a 3D mode of input to the application 147, without requiring restarting or rebooting the sensor module 110 and/or the computing device 141.

The system of FIG. 1 can automatically configured the sensor module 110 to transmit using the human interface device protocol 303 or using the universal asynchronous receiver-transmitter protocol 305 without user intervention. For example, based on the availability of the sensor module tool 343 in the computing device 141, the computing device 141 can automatically set the sensor module 110 to transmit 2D inputs using the human interface device protocol 303, or 3D inputs using the universal asynchronous receiver-transmitter protocol 305. For example, when the sensor module tool 343 is available in the computing device 141, the application 147 can indicate to the sensor module tool 343 whether it is in a 2D user interface or a 3D user interface and cause the computing device 141 to automatically change to the human interface device protocol 303 for the 2D user interface, to the universal asynchronous receiver-transmitter protocol 305 for the 3D user interface, without user intervention.

A conventional service based on a universal asynchronous receiver-transmitter protocol is typically configured to transfer raw data without any synchronization between devices. It is typically used for a wire connection and does not provide parcel and communication environment standards. Preferably, the sensor module 110 uses a customized version of the universal asynchronous receiver-transmitter protocol that supports communications over a wireless connection (e.g., Bluetooth Low Energy (BLE)). Thus, data parcel can be customized according to information needed in the computing device 141.

When the sensor module tool 343 is used with the universal asynchronous receiver-transmitter protocol 305 to transmit input as data 333, the sensor module 110 can realize its full potential of powering the application 147 with 3D motion-based inputs. All input data generated by the inertial measurement unit 315 and the optional input devices 309 of the sensor module 110 can be communicated to the computing device 141 for use in the application 147. The data 333 can include acceleration, angular velocity, orientation, position, etc., in a three dimensional space, in additional to input data generated by input devices 309, such as a state of a touch pad, a touch pad gesture, a state of a force sensor/button, a state of a proximity sensor, etc.

When the human interface device protocol 303 is used, the 3D inputs are mapped to a two dimensional space to generate inputs that are typically used for a conventional 2D user interface. In some implementations, when the computing device 141 does not support a sensor module tool 343, the sensor module 110 can be recognized as a standardized input device that uses the human interface device protocol 303 using default drivers 345. Thus, the sensor module 110 can generate 2D inputs for the computing device 141 in a mode of emulating standardized input devices, such as a computer mouse, keyboard, game controller, etc. For example, the 3D motion data generated by the inertial measurement unit 315 can be projected to a 2D plane to emulate a computer mouse pointer in the data 335, which can also include input data generated by input devices 309, such as a state of a touch pad, a touch pad gesture, a state of a force sensor/button, a state of a proximity sensor, etc.

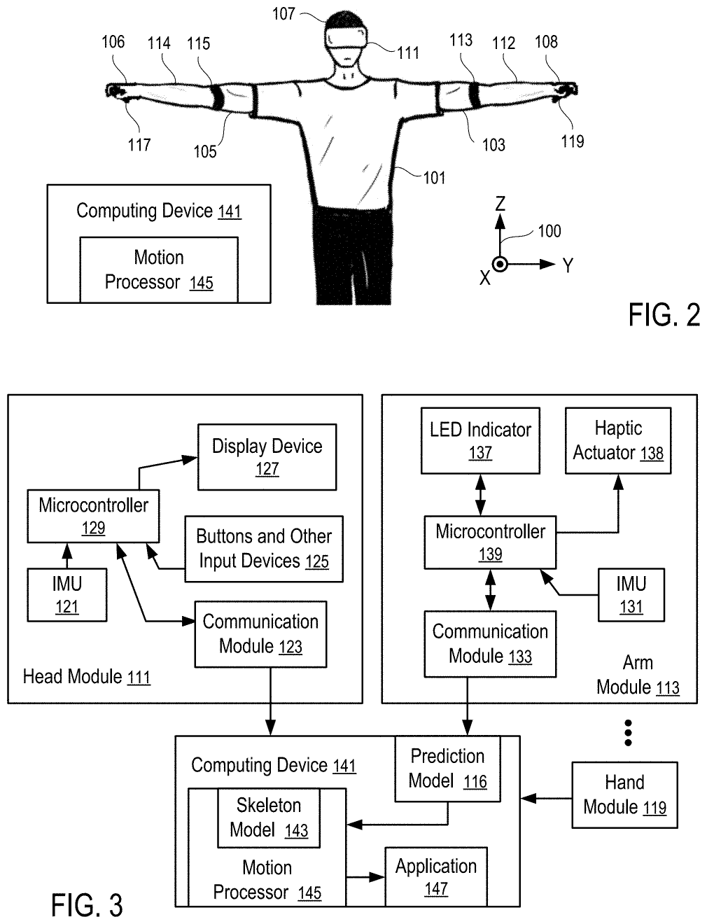

FIG. 2 illustrates a system to track user movements according to one embodiment.

FIG. 2 illustrates various parts of a user, such as the torso 101 of the user, the head 107 of the user, the upper arms 103 and 105 of the user, the forearms 112 and 114 of the user, and the hands 106 and 108 of the user. Each of such parts of the user can be modeled as a rigid part of a skeleton model of the user in a computing device; and the positions, orientations, and/or motions of the rigid parts connected via joints in the skeleton model in a VR/MR/AR/XR/IoT application can be controlled by tracking the corresponding positions, orientations, and/or motions of the parts of the user.

In FIG. 2, the hands 106 and 108 of the user can be considered rigid parts movable around the wrists of the user. In other applications, the palms and finger bones of the user can be further tracked to determine their movements, positions, and/or orientations relative to finger joints to determine hand gestures of the user made using relative positions among fingers of a hand and the palm of the hand.

In FIG. 2, the user wears several sensor models to track the orientations of parts of the user that are considered, recognized, or modeled as rigid in an application. The sensor modules can include a head module 111, arm modules 113 and 115, and/or hand modules 117 and 119. The sensor modules can measure the motion of the corresponding parts of the user, such as the head 107, the upper arms 103 and 105, and the hands 106 and 108 of the user. Since the orientations of the forearms 112 and 114 of the user can be predicted or calculated from the orientation of the upper arms 103 and 105, and the hands 106 and 108 of the user, the system as illustrated in FIG. 2 can track the positions and orientations of kinematic chains involving the forearms 112 and 114 without the user wearing separate/additional sensor modules on the forearms 112 and 114.

In general, the position and/or orientation of a part in a reference system 100 can be tracked using one of many systems known in the field. For example, an optical-based tracking system can use one or more cameras to capture images of a sensor module marked using optical markers and analyze the images to compute the position and/or orientation of the part. For example, an inertial-based tracking system can use a sensor module having an inertial measurement unit to determine its position and/or orientation and thus the position and/or orientation of the part of the user wearing the sensor module. Other systems may track the position of a part of the user based on signals transmitted from, or received at, a sensor module attached to the part. Such signals can be radio frequency signals, infrared signals, ultrasound signals, etc. The measurements from different tracking system can be combined via a Kalman-type filter, an artificial neural network, etc.

In one embodiment, the modules 111, 113, 115, 117 and 119 can be used both in an optical-based tracking system and an inertial-based tracking system. For example, a module (e.g., 113, 115, 117 and 119) can have one or more LED indicators to function as optical markers; when the optical markers are in the field of view of one or more cameras in the head module 111, images captured by the cameras can be analyzed to determine the position and/or orientation of the module. Further, each of the modules (e.g., 111, 113, 115, 117 and 119) can have an inertial measurement unit to measure its acceleration and/or rotation and thus to determine its position and/or orientation. The system can dynamically combine the measurements from the optical-based tracking system and the inertial-based tracking system (e.g., using a Kalman-type filter or an artificial neural network) for improved accuracy and/or efficiency.

Once the positions and/or orientations of some parts of the user are determined using the combined measurements from the optical-based tracking system and an inertial-based tracking system, the positions and/or orientations of some parts of the user having omitted sensor modules can be predicted and/or computed using the techniques, discussed in above-referenced patent documents, based on patterns of motions of the user. Thus, user experiences and cost of the system can be improved.

In FIG. 2, a computing device 141 is configured with a motion processor 145. The motion processor 145 combines the measurements from the optical-based tracking system and the measurements from the inertial-based tracking system (e.g., using a Kalman-type of filter) to generate improved measurements with reduced measurement delay, reduce drift errors, and/or a high rate of measurements.

For example, to make a measurement of the position and/or orientation of an arm module 113 or 115, or a hand module 117 or 119, the camera of the head module 111 can capture a pair of images representative of a stereoscopic view of the module being captured in the images. The images can be provided to the computing device 141 to determine the position and/or orientation of the module relative to the head 107, or stationary features of the surrounding observable in the images captured by the cameras, based on the optical markers of the sensor module captured in the images.

For example, to make a measurement of the position and/or orientation of the sensor module, the accelerometer, the gyroscope, and the magnetometer in the sensor module can provide measurement inputs. A prior position and/or orientation of the sensor module and the measurement from the accelerometer, the gyroscope, and the magnetometer can be combined with the lapsed time to determine the position and/or orientation of the sensor module at the time of the current measurement.

In FIG. 2, the sensor modules 111, 113, 115, 117 and 119 communicate their movement measurements to the computing device 141, which computes or predicts the orientation of the parts of the user, which are modeled as rigid parts on kinematic changes, such as forearms 112 and 114, upper arms 103 and 105, hands 106 and 108, torso 101 and head 107.

The head module 111 can include one or more cameras to implement an optical-based tracking system to determine the positions and orientations of other sensor modules 113, 115, 117 and 119. Each of the sensor modules 111, 113, 115, 117 and 119 can have accelerometers and gyroscopes to implement an inertial-based tracking system for their positions and orientations.

In some implementations, each of the sensor modules 111, 113, 115, 117 and 119 communicates its measurements directly to the computing device 141 in a way independent from the operations of other sensor modules. Alternatively, one of the sensor modules 111, 113, 115, 117 and 119 may function as a base unit that receives measurements from one or more other sensor modules and transmit the bundled and/or combined measurements to the computing device 141. In some implementations, the computing device 141 is implemented in a base unit, or a mobile computing device, and used to generate the predicted measurements for an AR/MRNR/XR/IoT application.

Preferably, wireless connections made via a personal area wireless network (e.g., Bluetooth connections), or a local area wireless network (e.g., Wi-Fi connections) are used to facilitate the communication from the sensor modules 111, 113, 115, 117 and 119 to the computing device 141. Alternatively, wired connections can be used to facilitate the communication among some of the sensor modules 111, 113, 115, 117 and 119 and/or with the computing device 141.

For example, a hand module 117 or 119 attached to or held in a corresponding hand 106 or 108 of the user may receive the motion measurements of a corresponding arm module 115 or 113 and transmit the motion measurements of the corresponding hand 106 or 108 and the corresponding upper arm 105 or 103 to the computing device 141.

Optionally, the hand 106, the forearm 114, and the upper arm 105 can be considered a kinematic chain, for which an artificial neural network can be trained to predict the orientation measurements generated by an optical track system, based on the sensor inputs from the sensor modules 117 and 115 that are attached to the hand 106 and the upper arm 105, without a corresponding device on the forearm 114.

Optionally or in combination, the hand module (e.g., 117) may combine its measurements with the measurements of the corresponding arm module 115 to compute the orientation of the forearm connected between the hand 106 and the upper arm 105, in a way as disclosed in U.S. Pat. No. 10,379,613, issued Aug. 13, 2019 and entitled “Tracking Arm Movements to Generate Inputs for Computer Systems”, the entire disclosure of which is hereby incorporated herein by reference.

For example, the hand modules 117 and 119 and the arm modules 115 and 113 can be each respectively implemented via a base unit (or a game controller) and an arm/shoulder module discussed in U.S. Pat. No. 10,509,469, issued Dec. 17, 2019 and entitled “Devices for Controlling Computers based on Motions and Positions of Hands”, the entire disclosure of which application is hereby incorporated herein by reference.

In some implementations, the head module 111 is configured as a base unit that receives the motion measurements from the hand modules 117 and 119 and the arm modules 115 and 113 and bundles the measurement data for transmission to the computing device 141. In some instances, the computing device 141 is implemented as part of the head module 111. The head module 111 may further determine the orientation of the torso 101 from the orientation of the arm modules 115 and 113 and/or the orientation of the head module 111, using an artificial neural network trained for a corresponding kinematic chain, which includes the upper arms 103 and 105, the torso 101, and/or the head 107.

For the determination of the orientation of the torso 101, the hand modules 117 and 119 are optional in the system illustrated in FIG. 2.

Further, in some instances the head module 111 is not used in the tracking of the orientation of the torso 101 of the user.

Typically, the measurements of the sensor modules 111, 113, 115, 117 and 119 are calibrated for alignment with a common reference system, such as a reference system 100.

After the calibration, the hands 106 and 108, the arms 103 and 105, the head 107, and the torso 101 of the user may move relative to each other and relative to the reference system 100. The measurements of the sensor modules 111, 113, 115, 117 and 119 provide orientations of the hands 106 and 108, the upper arms 105, 103, and the head 107 of the user relative to the reference system 100. The computing device 141 computes, estimates, or predicts the current orientation of the torso 101 and/or the forearms 112 and 114 from the current orientations of the upper arms 105, 103, the current orientation the head 107 of the user, and/or the current orientation of the hands 106 and 108 of the user and their orientation history using the prediction model 116.

Optionally or in combination, the computing device 141 may further compute the orientations of the forearms from the orientations of the hands 106 and 108 and upper arms 105 and 103, e.g., using a technique disclosed in U.S. Pat. No. 10,379,613, issued Aug. 13, 2019 and entitled “Tracking Arm Movements to Generate Inputs for Computer Systems”, the entire disclosure of which is hereby incorporated herein by reference.

FIG. 3 illustrates a system to control computer operations according to one embodiment. For example, the system of FIG. 3 can be implemented via attaching the arm modules 115 and 113 to the upper arms 105 and 103 respectively, the head module 111 to the head 107 and/or hand modules 117 and 119, in a way illustrated in FIG. 2.

In FIG. 3, the head module 111 and the arm module 113 have micro-electromechanical system (MEMS) inertial measurement units 121 and 131 that measure motion parameters and determine orientations of the head 107 and the upper arm 103.

Similarly, the hand modules 117 and 119 can also have inertial measurement units (IMUs). In some applications, the hand modules 117 and 119 measure the orientation of the hands 106 and 108 and the movements of fingers are not separately tracked. In other applications, the hand modules 117 and 119 have separate IMUs for the measurement of the orientations of the palms of the hands 106 and 108, as well as the orientations of at least some phalange bones of at least some fingers on the hands 106 and 108. Examples of hand modules can be found in U.S. Pat. No. 10,534,431, issued filed Jan. 14, 2020 and entitled “Tracking Finger Movements to Generate Inputs for Computer Systems,” the entire disclosure of which is hereby incorporated herein by reference.

Each of the Inertial Measurement Unit 131 and 121 has a collection of sensor components that enable the determination of the movement, position and/or orientation of the respective IMU along a number of axes. Examples of the components are: a MEMS accelerometer that measures the projection of acceleration (the difference between the true acceleration of an object and the gravitational acceleration); a MEMS gyroscope that measures angular velocities; and a magnetometer that measures the magnitude and direction of a magnetic field at a certain point in space. In some embodiments, the IMUs use a combination of sensors in three and two axes (e.g., without a magnetometer).

The computing device 141 has a prediction model 116 and a motion processor 145. The measurements of the Inertial Measurement Units (e.g., 131, 121) from the head module 111, arm modules (e.g., 113 and 115), and/or hand modules (e.g., 117 and 119) are used in the prediction model 116 to generate predicted measurements of at least some of the parts that do not have attached sensor modules, such as the torso 101, and forearms 112 and 114. The predicted measurements and/or the measurements of the Inertial Measurement Units (e.g., 131, 121) are used in the motion processor 145.

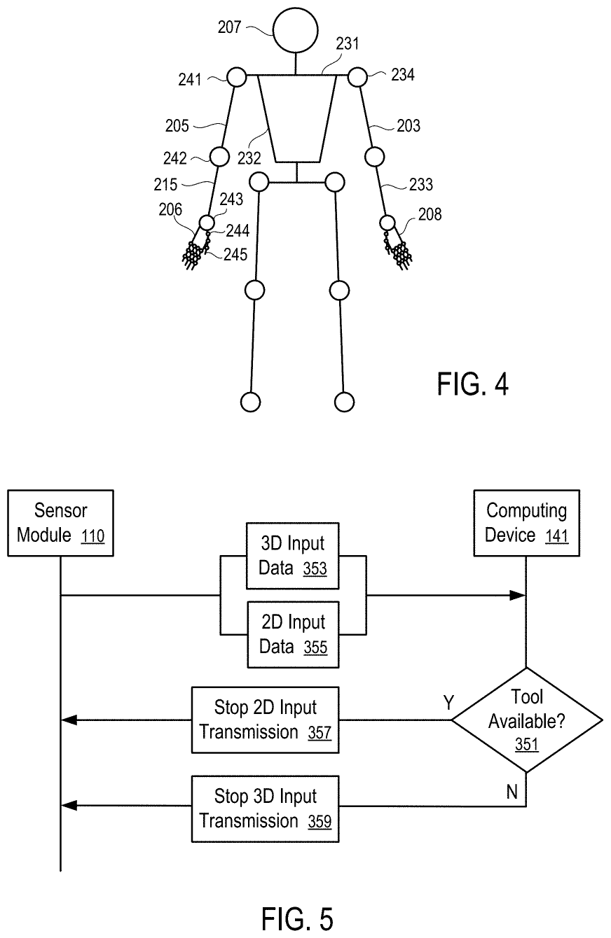

The motion processor 145 has a skeleton model 143 of the user (e.g., illustrated FIG. 4). The motion processor 145 controls the movements of the parts of the skeleton model 143 according to the movements/orientations of the corresponding parts of the user. For example, the orientations of the hands 106 and 108, the forearms 112 and 114, the upper arms 103 and 105, the torso 101, the head 107, as measured by the IMUs of the hand modules 117 and 119, the arm modules 113 and 115, the head module 111 sensor modules and/or predicted by the prediction model 116 based on the IMU measurements are used to set the orientations of the corresponding parts of the skeleton model 143.

Since the torso 101 does not have a separately attached sensor module, the movements/orientation of the torso 101 is predicted using the prediction model 116 using the sensor measurements from sensor modules on a kinematic chain that includes the torso 101. For example, the prediction model 116 can be trained with the motion pattern of a kinematic chain that includes the head 107, the torso 101, and the upper arms 103 and 105 and can be used to predict the orientation of the torso 101 based on the motion history of the head 107, the torso 101, and the upper arms 103 and 105 and the current orientations of the head 107, and the upper arms 103 and 105.

Similarly, since a forearm 112 or 114 does not have a separately attached sensor module, the movements/orientation of the forearm 112 or 114 is predicted using the prediction model 116 using the sensor measurements from sensor modules on a kinematic chain that includes the forearm 112 or 114. For example, the prediction model 116 can be trained with the motion pattern of a kinematic chain that includes the hand 106, the forearm 114, and the upper arm 105 and can be used to predict the orientation of the forearm 114 based on the motion history of the hand 106, the forearm 114, the upper arm 105 and the current orientations of the hand 106, and the upper arm 105.

The skeleton model 143 is controlled by the motion processor 145 to generate inputs for an application 147 running in the computing device 141. For example, the skeleton model 143 can be used to control the movement of an avatar/model of the arms 112, 114, 105 and 103, the hands 106 and 108, the head 107, and the torso 101 of the user of the computing device 141 in a video game, a virtual reality, a mixed reality, or augmented reality, etc.

Preferably, the arm module 113 has a microcontroller 139 to process the sensor signals from the IMU 131 of the arm module 113 and a communication module 133 to transmit the motion/orientation parameters of the arm module 113 to the computing device 141. Similarly, the head module 111 has a microcontroller 129 to process the sensor signals from the IMU 121 of the head module 111 and a communication module 123 to transmit the motion/orientation parameters of the head module 111 to the computing device 141.

Optionally, the arm module 113 and the head module 111 have LED indicators 137 respectively to indicate the operating status of the modules 113 and 111.

Optionally, the arm module 113 has a haptic actuator 138 respectively to provide haptic feedback to the user.

Optionally, the head module 111 has a display device 127 and/or buttons and other input devices 125, such as a touch sensor, a microphone, a camera, etc.

In some implementations, the head module 111 is replaced with a module that is similar to the arm module 113 and that is attached to the head 107 via a strap or is secured to a head mount display device.

In some applications, the hand module 119 can be implemented with a module that is similar to the arm module 113 and attached to the hand via holding or via a strap. Optionally, the hand module 119 has buttons and other input devices, such as a touch sensor, a joystick, etc.

For example, the handheld modules disclosed in U.S. Pat. No. 10,534,431, issued Jan. 14, 2020 and entitled “Tracking Finger Movements to Generate Inputs for Computer Systems”, U.S. Pat. No. 10,379,613, issued Aug. 13, 2019 and entitled “Tracking Arm Movements to Generate Inputs for Computer Systems”, and/or U.S. Pat. No. 10,509,469, issued Dec. 17, 2019 and entitled “Devices for Controlling Computers based on Motions and Positions of Hands” can be used to implement the hand modules 117 and 119, the entire disclosures of which applications are hereby incorporated herein by reference.

When a hand module (e.g., 117 or 119) tracks the orientations of the palm and a selected set of phalange bones, the motion pattern of a kinematic chain of the hand captured in the prediction model 116 can be used in the prediction model 116 to predict the orientations of other phalange bones that do not wear sensor modules.

FIG. 3 shows a hand module 119 and an arm module 113 as examples. In general, an application for the tracking of the orientation of the torso 101 typically uses two arm modules 113 and 115 as illustrated in FIG. 2. The head module 111 can be used optionally to further improve the tracking of the orientation of the torso 101. Hand modules 117 and 119 can be further used to provide additional inputs and/or for the prediction/calculation of the orientations of the forearms 112 and 114 of the user.

Typically, an Inertial Measurement Unit (e.g., 131 or 121) in a module (e.g., 113 or 111) generates acceleration data from accelerometers, angular velocity data from gyrometers/gyroscopes, and/or orientation data from magnetometers. The microcontrollers 139 and 129 perform preprocessing tasks, such as filtering the sensor data (e.g., blocking sensors that are not used in a specific application), applying calibration data (e.g., to correct the average accumulated error computed by the computing device 141), transforming motion/position/orientation data in three axes into a quaternion, and packaging the preprocessed results into data packets (e.g., using a data compression technique) for transmitting to the host computing device 141 with a reduced bandwidth requirement and/or communication time.

Each of the microcontrollers 129, 139 may include a memory storing instructions controlling the operations of the respective microcontroller 129 or 139 to perform primary processing of the sensor data from the IMU 121, 131 and control the operations of the communication module 123, 133, and/or other components, such as the LED indicator 137, the haptic actuator 138, buttons and other input devices 125, the display device 127, etc.

The computing device 141 may include one or more microprocessors and a memory storing instructions to implement the motion processor 145. The motion processor 145 may also be implemented via hardware, such as Application-Specific Integrated Circuit (ASIC) or Field-Programmable Gate Array (FPGA).

In some instances, one of the modules 111, 113, 115, 117, and/or 119 is configured as a primary input device; and the other module is configured as a secondary input device that is connected to the computing device 141 via the primary input device. A secondary input device may use the microprocessor of its connected primary input device to perform some of the preprocessing tasks. A module that communicates directly to the computing device 141 is consider a primary input device, even when the module does not have a secondary input device that is connected to the computing device via the primary input device.

In some instances, the computing device 141 specifies the types of input data requested, and the conditions and/or frequency of the input data; and the modules 111, 113, 115, 117, and/or 119 report the requested input data under the conditions and/or according to the frequency specified by the computing device 141. Different reporting frequencies can be specified for different types of input data (e.g., accelerometer measurements, gyroscope/gyrometer measurements, magnetometer measurements, position, orientation, velocity).

In general, the computing device 141 may be a data processing system, such as a mobile phone, a desktop computer, a laptop computer, a head mount virtual reality display, a personal medial player, a tablet computer, etc.

FIG. 4 illustrates a skeleton model that can be controlled by tracking user movements according to one embodiment. For example, the skeleton model of FIG. 4 can be used in the motion processor 145 of FIG. 3.

The skeleton model illustrated in FIG. 4 includes a torso 232 and left and right upper arms 203 and 205 that can move relative to the torso 232 via the shoulder joints 234 and 241. The skeleton model may further include the forearms 215 and 233, hands 206 and 208, neck, head 207, legs and feet. In some instances, a hand 206 includes a palm connected to phalange bones (e.g., 245) of fingers, and metacarpal bones of thumbs via joints (e.g., 244).

The positions/orientations of the rigid parts of the skeleton model illustrated in FIG. 4 are controlled by the measured orientations of the corresponding parts of the user illustrated in FIG. 2. For example, the orientation of the head 207 of the skeleton model is configured according to the orientation of the head 107 of the user as measured using the head module 111; the orientation of the upper arm 205 of the skeleton model is configured according to the orientation of the upper arm 105 of the user as measured using the arm module 115; and the orientation of the hand 206 of the skeleton model is configured according to the orientation of the hand 106 of the user as measured using the hand module 117; etc.

The prediction model 116 can have multiple artificial neural networks trained for different motion patterns of different kinematic chains.

For example, a clavicle kinematic chain can include the upper arms 203 and 205, the torso 232 represented by the clavicle 231, and optionally the head 207, connected by shoulder joints 241 and 234 and the neck. The clavicle kinematic chain can be used to predict the orientation of the torso 232 based on the motion history of the clavicle kinematic chain and the current orientations of the upper arms 203 and 205, and the head 207.

For example, a forearm kinematic chain can include the upper arm 205, the forearm 215, and the hand 206 connected by the elbow joint 242 and the wrist joint 243. The forearm kinematic chain can be used to predict the orientation of the forearm 215 based on the motion history of the forearm kinematic chain and the current orientations of the upper arm 205, and the hand 206.

For example, a hand kinematic chain can include the palm of the hand 206, phalange bones 245 of fingers on the hand 206, and metacarpal bones of the thumb on the hand 206 connected by joints in the hand 206. The hand kinematic chain can be used to predict the orientation of the phalange bones and metacarpal bones based on the motion history of the hand kinematic chain and the current orientations of the palm, and a subset of the phalange bones and metacarpal bones tracked using IMUs in a hand module (e.g., 117 or 119).

For example, a torso kinematic chain may include clavicle kinematic chain and further include forearms and/or hands and legs. For example, a leg kinematic chain may include a foot, a lower leg, and an upper leg.

An artificial neural network of the prediction model 116 can be trained using a supervised machine learning technique to predict the orientation of a part in a kinematic chain based on the orientations of other parts in the kinematic chain such that the part having the predicted orientation does not have to wear a separate sensor module to track its orientation.

Further, an artificial neural network of the prediction model 116 can be trained using a supervised machine learning technique to predict the orientations of parts in a kinematic chain that can be measured using one tracking technique based on the orientations of parts in the kinematic chain that are measured using another tracking technique.

For example, the tracking system as illustrated in FIG. 3 measures the orientations of the modules 111, 113, . . . , 119 using Inertial Measurement Units (e.g., 121, 131, . . . ). The inertial-based sensors offer good user experiences, have less restrictions on the use of the sensors, and can be implemented in a computational efficient way. However, the inertial-based sensors may be less accurate than certain tracking methods in some situations, and can have drift errors and/or accumulated errors through time integration.

For example, an optical tracking system can use one or more cameras to track the positions and/or orientations of optical markers that are in the fields of view of the cameras. When the optical markers are within the fields of view of the cameras, the images captured by the cameras can be used to compute the positions and/or orientations of optical markers and thus the orientations of parts that are marked using the optical markers. However, the optical tracking system may not be as user friendly as the inertial-based tracking system and can be more expensive to deploy. Further, when an optical marker is out of the fields of view of cameras, the positions and/or orientations of optical marker cannot be determined by the optical tracking system.

An artificial neural network of the prediction model 116 can be trained to predict the measurements produced by the optical tracking system based on the measurements produced by the inertial-based tracking system. Thus, the drift errors and/or accumulated errors in inertial-based measurements can be reduced and/or suppressed, which reduces the need for re-calibration of the inertial-based tracking system.

FIG. 5 shows a technique to automatically configure the transmission protocol between a sensor module 110 and a computing device 141 according to one embodiment.

For example, the technique can be implemented in the system of FIG. 1. The sensor modules 111, 113, . . . , 119 in the systems of FIGS. 1 and 2 can communicate with the corresponding computing device 141 in FIG. 2 and FIG. 3 using the technique to control a skeleton model of FIG. 4 in a VR/AR/XR/MR application 147 or an IoT application.

In FIG. 5, when the sensor module 110 is powered on, the sensor module 110 can establish a communication link 331 to the computing device 141 (e.g., using a Bluetooth wireless connection).

Through the communication link 331, the sensor module 110 can simultaneously or concurrently transmit 2D input data 355 and 3D input data 353.

For example, the 3D motion input data generated by an inertial measurement unit (e.g., 315, 121, 131) can be projected to a 2D plane to generate the 2D input data 355 in emulating a 2D input device. The 2D input data can be transmitted via a human interface device protocol 303 so that it is readily recognizable and/or usable in the computing device 141 running a typical operating system. One or more default input device drivers 345 can process the inputs from the emulated 2D input device. Thus, at least the 2D input data 355 can be used by the computing device 141 without customizing the computing device 141.

A custom tool 343 or driver can be installed in the computing device 141 to add the capability of handling 3D inputs to the computing device 141. The 3D inputs can be transmitted using a universal asynchronous receiver-transmitter protocol 305.

In response to the input data 353 and 355 from the sensor module 110, the computing device 141 can determine 351 whether the custom tool 343 or driver is available to recognize and/or use the 3D input data 353. If so, the computing device 141 can send a command to stop 357 2D input transmission from the sensor module 110. Otherwise, another command can be sent to stop 359 the sensor module 110 from transmitting the 3D input.

In some instances, it is advantageous to transmit both the 3D input data 353 and the 2D input data. For example, the 2D inputs generated by the input device 309 (or buttons 125 and other input devices) can be transmitted using the human interface device protocol 303; and the 3D inputs generated by the inertial measurement unit (e.g., 315, 121, 131) can be transmitted via the universal asynchronous receiver-transmitter protocol 305.

Optionally, depending on the context of the application 147, the computing device 141 can send comments to request the sensor module 110 to switch between transmitting 3D input data 353 and transmitting 2D input data 355, or to stop one or both of the 2D and 3D input transmission, or to restart transmission of one or both of the 2D and 3D input transmission. The protocol configuration can be performed via automated communications between the sensor module 110 and the computing device 141 without user intervention and without reboot or restarting the sensor module 110 and/or the computing device 141.

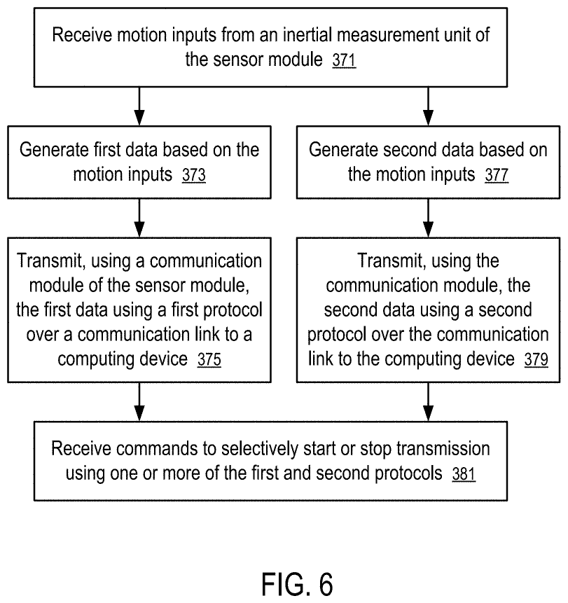

FIG. 6 shows a method to support dynamic protocol selection in a sensor module according to one embodiment.

For example, the method of FIG. 6 can be implemented in the system of FIG. 1 and/or FIG. 2, using sensor modules illustrated in FIG. 3 to control a skeleton model of FIG. 4 in an AR/XR/MR/VR application 147 or an IoT application/device, using the technique of FIG. 5.

At block 371, a microcontroller 313 of a sensor module (e.g., 110, 111, 113, . . . , 119) configured via firmware 301 receives motion inputs from an inertial measurement unit (e.g., 315, 121, . . . , 131). The motion inputs are measured in a three dimensional space. The motion inputs can include accelerometer measurements in the three dimensional space and the gyroscope measurements in the three dimensional space.

At block 373, the microcontroller 313 generates first data (e.g., 335 and/or 355) based on the motion inputs.

At block 375, the sensor module (e.g., 110, 111, 113, . . . , 119) transmits, using a communication module (e.g., 311, 123, 133, . . . ) of the sensor module, the first data using a first protocol over a communication link 331 to a computing device 141.

For example, the communication link 331 can be a Bluetooth wireless connection.

For example, the first protocol can be a Human Interface Device Protocol 303 such that the first data (e.g., 335 and/or 355) is recognizable and/or usable by default drivers of a typical operating system 341. Such default drivers are configured to process inputs from conventional and/or standardized input devices, such as keyboards, computer mice, game controllers, touch pads, touch screens, etc. In some instances, the sensor module (e.g., 110 or 111) can have such input devices (e.g., 309, 125) traditionally used in 2D graphical user interfaces.

For example, the sensor module 110 can have a touch pad, a joystick, a trigger, a button, a track ball, or a track stick, or any combination thereof, in addition to the inertial measurement unit 315. When the inputs of the input devices (e.g., 309, 125) are combined with the 3D motion data of the sensor module 110, the conventional 2D inputs can be mapped to 3D inputs associated with the 3D position and/or orientation of the sensor module 110.

For example, the 3D motion input can be projected to a plane or surface to generate a 2D input that emulating a conventional cursor pointing device, such as a computer mouse. Thus, at least the 2D input can be used by the computing device 141.

At block 377, the microcontroller 313 generates second data (e.g., 333 and/or 353) based on the motion inputs.

For example, the same Bluetooth wireless connection can be used as the communication link 331 to transmit the second data (e.g., 333 and/or 353) using a universal asynchronous receiver-transmitter protocol 305. The second data (e.g., 333 and/or 353) can include 3D input data based on the motion data of the inertial measurement unit (e.g., 315, 121, . . . , 131). The 3D input data can include position, orientation, velocity, acceleration, rotation, etc. in a 3D space.

Since a typical operating system does not have a driver readily available to process such 3D data, a custom sensor module tool 343 can be installed to add the 3D input capability to the computing device 141. Depending on the 3D input capability of the computing device 141, the 3D input may or may not be used.

At block 379, the sensor module (e.g., 110, 111, 113, . . . , 119) transmits, using the communication module (e.g., 311, 123, 133, . . . ) of the sensor module, the second data using a second protocol over the communication link 331 to the computing device.

The transmissions in the first protocol and the second protocol can be performed concurrently in a same period of time without rebooting or restarting execution of the firmware 301

At block 381, the sensor module (e.g., 110, 111, 113, . . . , 119) receives commands (from the computing device 141) to selectively start or stop transmission using one or more of the first and second protocols. Thus, the sensor module can be dynamically configured to transmit 2D and/or 3D inputs using different protocols without rebooting or restarting execution of the firmware 301, and without user intervention.

For example, if the computing device 141 lacks the 3D input capability (e.g., offered by the sensor module tool 343), the computing device 141 can send a command to request the sensor module 110 to stop transmitting the 3D input data.

For example, if the computing device 141 has the 3D input capability (e.g., offered by the sensor module tool 343), the computing device 141 can optionally send a command to request the sensor module 110 to stop transmitting the 2D input data. In some instances, when the application 147 is running in a 2D mode, the computing device 141 can instruct the sensor module 110 to stop 3D input and start 2D input; and when the application 147 is running in a 3D VR/AR/MR/XR/IoT mode, the computing device 141 can instruct the sensor module 110 to stop 2D input and start 3D input. In some instances, the application 147 can handle a combination of 2D and 3D inputs; and the computing device 141 can request the sensor module 110 to transmit both the 2D input data and 3D input data.

The present disclosure includes methods and apparatuses which perform these methods, including data processing systems which perform these methods, and computer readable media containing instructions which when executed on data processing systems cause the systems to perform these methods.

For example, the computing device 141, the arm modules 113, 115 and/or the head module 111 can be implemented using one or more data processing systems.

A typical data processing system may include includes an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A sensor module, comprising:
an inertial measurement unit;
a communication module; and
a microcontroller configured via firmware to:
receive motion inputs from the inertial measurement unit;
generate first data based on the motion inputs;
instruct the communication module to transmit the first data using a first protocol over a communication link to a computing device;
generating second data based on the motion inputs; and
instruct the communication module to transmit the second data using a second protocol over the communication link to the computing device, wherein the first protocol and the second protocol are used to transmit concurrently during a period of time without restarting execution of the firmware.

2. The sensor module of claim 1, further comprising:
an input device configured to generate inputs for a two dimensional user interface.

3. The sensor module of claim 2, wherein the input device includes a touch pad, a joystick, a trigger, a button, a track ball, or a track stick, or any combination thereof.

4. The sensor module of claim 3, wherein the motion inputs from the inertial measurement unit and the second data are measured in a three dimensional space; and the first data is configured in a two dimensional space.

5. The sensor module of claim 4, wherein the first protocol is a human interface device protocol; and the second protocol is a universal asynchronous receiver-transmitter protocol.

6. The sensor module of claim 5, wherein the first protocol is supported by a default driver of an operating system in the computing device; and a second protocol is supported by a custom tool installed in the operating system. 7 The sensor module of claim 6, wherein in response to a first command from the computing device, the microcontroller is configured to stop transmitting through the communication module using the first protocol; and in response to a second command from the computing device, the microcontroller is configured to stop transmitting through the communication module using the second protocol.

8. The sensor module of claim 7, wherein in response to a third command from the computing device, the microcontroller is configured to start transmitting through the communication module using the first protocol; and in response to a fourth command from the computing device, the microcontroller is configured to start transmitting through the communication module using the second protocol.

9. The sensor module of claim 8, wherein in absence of a command from the computing device to select a communication protocol, the microcontroller is configured to transmit both the first data and the second data concurrently using the first protocol and the second protocol respectively.

10. The sensor module of claim 9, wherein the microcontroller is configured to map the second data from the three dimensional space to the two dimensional space to generate the first data to emulate a cursor pointing device using the motion inputs from the inertial measurement unit.

11. A computing device, comprising:
a communication module; and
a microprocessor configured via instructions of an operating system and an application to:
establish a communication link from the communication module to a sensor module;
receive concurrently first data transmitted from the sensor module using a first protocol and second data transmitted from the sensor module using a second protocol;
direct the first data to a default driver of the operating system in absence of a custom tool installable in the computing device;
direct the second data to the custom tool in response to a determination that the custom tool is available in the computing device; and
provide the first data or the second data as input to the application.

12. The computing device of claim 11, wherein the first protocol supports user inputs configured in a two dimensional space; and the second protocol supports user inputs configured in a three dimensional space.

13. The computing device of claim 12, wherein the first protocol is a human interface device (HID) protocol; the second protocol is a universal asynchronous receiver-transmitter (UART) protocol; and the communication link is a Bluetooth wireless connection or a Bluetooth Low Energy (BLE) wireless connection.

14. The computing device of claim 13, wherein the operating system is configured with one or more default drivers to process inputs transmitted via the first protocol from a class of standardized input devices for a two dimensional graphical user interface; and the custom tool is configured to support three dimensional inputs generated using an inertial measurement unit in the sensor module.

15. The computing device of claim 14, wherein in response to a determination that the custom tool is available in the computing device, the microprocessor is configured to transmit a first command to the sensor module to instruct the sensor module stop transmitting using the first protocol; and in response to a determination that the custom tool is unavailable in the computing device, the microprocessor is configured to transmit a second command to the sensor module to instruct the sensor module stop transmitting using the second protocol.

16. The computing device of claim 15, wherein in response to a request from the custom tool or the application, the microprocessor is configured to request the sensor module to switch use of protocols in transmitting inputs from the sensor module.

17. A non-transitory computer storage medium storing instructions of firmware which, when executed in a sensor module, cause the sensor module to perform a method, comprising:
receiving motion inputs from an inertial measurement unit of the sensor module;
generating first data based on the motion inputs;
transmitting, using a communication module of the sensor module, the first data using a first protocol over a communication link to a computing device;
generating second data based on the motion inputs; and
transmitting, using the communication module, the second data using a second protocol over the communication link to the computing device, wherein the first protocol and the second protocol are used to transmit concurrently during a period of time without restarting execution of the firmware.

18. The non-transitory computer storage medium of claim 17, wherein the second data is three dimensional user input data; and the first data is two dimensional user input data generated from the second data to emulate a two dimensional user input device.

19. The non-transitory computer storage medium of claim 18, wherein the first protocol is a human interface device protocol; and the second protocol is a universal asynchronous receiver-transmitter protocol.

20. The non-transitory computer storage medium of claim 17, wherein the method further comprises:
selectively starting or stopping transmitting using the first protocol or the second protocol in response to commands from the computing device.
